(19) United States
(12) Patent Application Publication
(10) Pub. No.: US 2007/0000845 A1
(43) Pub. Date: Jan. 4, 2007

(54) Ballast water electromagnetic heating technique

(76) Inventor: Raymond S. Kasevich, Mt. Washington, MA (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/404,997

(22) Filed: Apr. 14, 2006

Related U.S. Application Data
(60) Provisional application No. 60/672,154, filed on Apr. 15, 2005.

(51) Int. Cl. C02F 1/32

(52) U.S. Cl. 210/748

(57) ABSTRACT

The present invention is a system and technique for the electromagnetic heating of ballast water to kill unwanted organisms. More specifically, the invention is based on a novel applicator design that is easily installed on ships or used in ports. It incorporates an array of channels that simultaneously heat, by electromagnetic means, and convey the water from storage, or into storage tanks. The applicator is basically a large hollow metal pipe containing open ended wave guide-like structures for water conveyance and heating.

### CROSS-REFERENCE TO RELATED APPLICATION(S)

This application claims priority from U.S. provisional patent application Ser. No. 60/672,154, which was filed on Apr. 15, 2005, and which is incorporated herein by reference in its entirety.

### FIELD OF THE INVENTION

The present invention generally relates to the use of electromagnetic energy to heat ballast water. More particularly, this invention relates to systems for using electromagnetic energy to heat ballast water inside ships to kill unwanted organisms in the water.

### BACKGROUND OF THE INVENTION

Ships engaged in worldwide shipping in international trade carry tons of ballast water around the world. Ballast water is essential to maintain the stability and safety of ships at sea. However, in recent years, there has been a growing recognition that the use and exchange of ballast water can be a vehicle for the introduction into local areas of harmful organisms, such as bacteria and non-indigenous plants and animals. Such transfers may threaten human health or result in severe ecological and environmental damage. As a result, there has been a growing need for methods and systems to kill unwanted organisms in ballast water.

Several methods have been proposed to eliminate unwanted organisms in ballast water. For example, ships may exchange ballast water at sea in deep ocean waters to minimize the organism content of the water. Emptying and refilling ballast tanks at sea, however, may endanger the ship. Alternatively, the water may be treated with chemicals to kill any unwanted organisms. That method may itself threaten the environment.

An alternative, environmentally safe option is to heat the ballast water. It is known that heating ballast water to 40 to 45° C. for very short periods of time will kill unwanted organisms in water. To provide a practical alternative, however, it is necessary to develop a safe and cost-effective method to heat the ballast water to that temperature. The present invention presents a system and technique for doing so. It should be noted that the applications of this invention are not limited to use to kill organisms in ballast water. For example, it may also be used to purify drinking water or water used in industrial applications.

### BRIEF SUMMARY OF THE INVENTION

Unwanted organisms in water present problems in a wide variety of circumstances. Water with such organisms may be unfit for drinking or industrial applications, and presents ecological problems in the context of ballast water. Heating such water effectively kills the unwanted organisms and purifies the water for these purposes. In certain circumstances, electromagnetic energy provides a relatively cost-effective and efficient means to heat the water.

In one embodiment of the present invention, a system may be provided for killing unwanted organisms in water. The system may comprise a first container for holding untreated water, a second container for holding treated water, at least one pipe connecting the first container to the second container, at least one helix plow wave structure in proximity to each such pipe, a radiofrequency generator attached to such helixes by coaxial cables, which generator excites the helixes to heat the water in the pipe or pipes, and a metal shield containing each such pipe and helix.

In one embodiment of the present invention, a system may be provided for use in killing unwanted organisms in water. The system may comprise a first container for holding untreated water, a second container for holding treated water, at least one larger diameter pipe connecting the first container to the second container, two or more smaller diameter pipes within the larger diameter pipe for conveying water from the first container to the second container, one helix plow wave structure wrapped around each such smaller diameter pipe, a radiofrequency generator attached to such helixes by coaxial cables, which generator excites the helixes to heat the water in the pipe or pipes, and a metal shield containing each such smaller diameter pipe and helix.

In one embodiment of the present invention, a method may be provided for killing unwanted organisms in water. The method may comprise running water through a pipe around which is wrapped a helix plow wave structure, exciting the helix with a radiofrequency generator, and electromagnetically heating the water to a temperature of at least 35° C.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of an embodiment of the present invention incorporating two helix plow wave structures, between which is a pipe through which water to be heat-treated flows.

FIG. 2 is a perspective view of an embodiment of the present invention incorporating two helix plow wave structures, within which are pipes through which water to be heat-treated flows.

FIG. 3 is a cross-sectional view of an embodiment of the present invention incorporating a circular array of helix plow wave structures and water-conveying pipes within a larger pipe.

### DETAILED DESCRIPTION

A system and technique that use electromagnetic heating of ballast water to kill unwanted organisms is proposed. More specifically, the invention is based on a novel applicator design that is easily installed on ships or used in ports. It incorporates an array of channels that simultaneously heat, by electromagnetic means, and convey the water from storage, or into storage tanks. The applicator is basically a large hollow metal pipe containing open ended wave guide-like structures for water conveyance and heating.

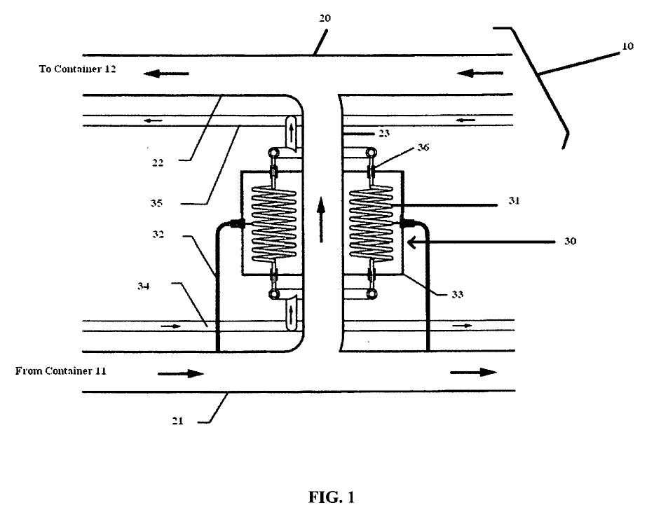

FIG. 1 is a perspective view of an embodiment of the present invention incorporating two helix plow wave structures, between which is a pipe through which water to be heat-treated flows. A possible wave guide-like structure 10 that simultaneously conveys and heats flowing water is described below. A pipe or tube 20, such as PVC, connects a container 11 that holds untreated water to a container 12 that holds treated water. Pipe portion 21 conveys untreated bilge water to one or more heating structures 30, while pipe portion 22 conveys processed water to container 12.

Heating structure 30 consists of two helix plow wave structures 31 on either side of water conveying tube 23. The helix plow wave structures 31 are excited by a radiofrequency generator (not pictured) attached to the helix plow wave structures 31 by coaxial cables 32. The magnetic field inside the helix plow wave structures 31 tend to be uniform and, by Faraday's Law of Induction, an axial component of electric field exists inside the coil and is fairly uniform throughout the cross-section. For impedance control and enhancement of the axial electric field inside the helix, capacitors maybe be placed between turns in such a way as to create a resonant geometry. The helix structures 31 are contained within a metal shield 33. Coil cooling water supply 34 supplies water to cool the helix structures 31; the cooling water flows through the helix structures 31 and is returned through coil cooling water return 35. Teflon insulating sleeves 36 cover the helix structures 31 where they enter and exit metal shield 33.

In operation, untreated water flows from the first container 11, though tube 20, to the second container 12. As the water flows through tube 20, it is electromagnetically heated by the operation of the heating structure 30. The temperature to which the water is heated can be controlled by the rate of flow of the water, the length and diameter of tube 23, the configuration of helix structure 31, and the radiofrequency used. For example, for a ballast water application, the diameter of tube 23 may be in the range of ½ to ¾ of a meter and the radiofrequency may be in the range 13.56 or 27.12 MHz.

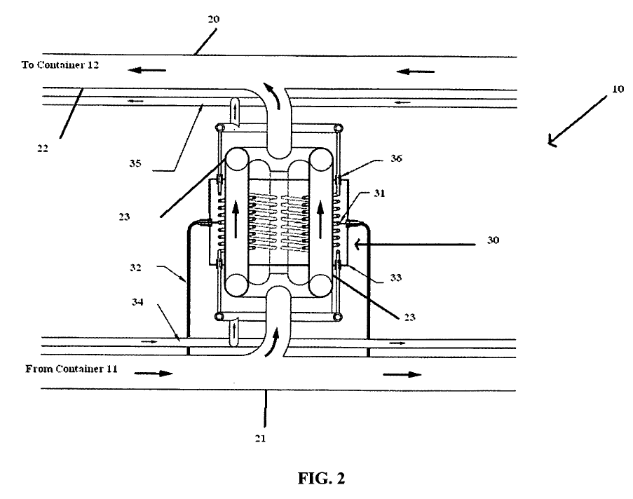

FIG. 2 is a perspective view of an embodiment of the present invention incorporating two helix plow wave structures, within which are pipes through which water to be heat-treated flows. In this embodiment, untreated water is conveyed from container 11 to heating structure 30 via tube 21. The untreated water is passed through heating structure 30 in water conveying tubes 23. Water conveying tubes 23 run within helix structures 31 and are thereby treated with heat created by the electromagnetic energy. The treated water is then conveyed to container 12 by tube 22.

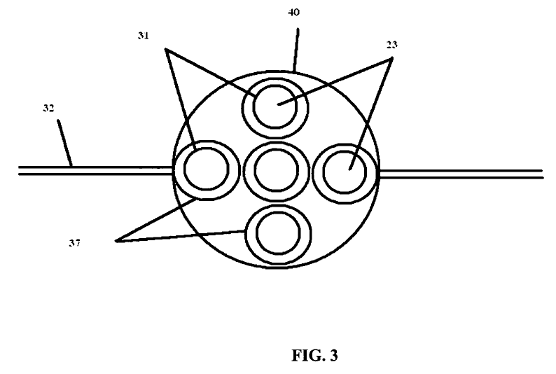

A circular array of such wave guide-like modules may be positioned within a larger diameter pipe for retrofitting to existing ship piping associated with ballast water conveyance. FIG. 3 shows a cross-sectional view of such a circular array. Metal pipe 40 connects untreated bilge water container 11 and treated water container 12. Several water conveying tubes 23 are within metal pipe 40 and convey water from container 11 to container 12. Helix structures 31 surround each of the water conveying tubes 23 are excited by a radiofrequency generator via coaxial cables 32. Each tube 23 and helix structure 31 are surrounded by a helix shield 37. The helix structures 31 heat the untreated water and thereby kill the organisms therein.

Although the present invention has been described with reference to preferred embodiments, persons skilled in the art will recognize that changes may be made in form and detail without departing from the spirit and scope of the invention.

What is claimed is:

1. A system for killing unwanted organisms in water, the system comprising:
a first container for holding untreated water;
a second container for holding treated water;
at least one pipe connecting the first container to the second container;
at least one helix plow wave structure in proximity to each such pipe;
a radiofrequency generator attached to such helixes by coaxial cables, which generator excites the helixes to heat the water in the pipe or pipes; and
a metal shield containing each such pipe and helix.

2. The system of claim 1 wherein the diameter the at least one pipe connecting the first container to the second container is in the range of ½ to ¾ of a meter.

3. The system of claim 1 wherein the radiofrequency generator generates a radiofrequency in the range 13.56 to 27.12 MHz.

4. The system of claim 1 wherein a helix plow wave structure is wrapped around each pipe.

5. The system of claim 4 wherein the diameter the at least one pipe connecting the first container to the second container is in the range of ½ to ¾ of a meter.

6. The system of claim 4 wherein the radiofrequency generator generates a radiofrequency in the range 13.56 to 27.12 MHz.

7. A system for killing unwanted organisms in water, the system comprising:
a first container for holding untreated water;
a second container for holding treated water;
at least one larger diameter pipe connecting the first container to the second container;
two or more smaller diameter pipes within the larger diameter pipe for conveying water from the first container to the second container;
one helix plow wave structure wrapped around each such smaller diameter pipe;
a radiofrequency generator attached to such helixes by coaxial cables, which generator excites the helixes to heat the water in the pipe or pipes; and
a metal shield containing each such smaller diameter pipe and helix.

8. The system of claim 7 wherein the radiofrequency generator generates a radiofrequency in the range 13.56 to 27.12 MHz.

9. A method for killing unwanted organisms in water, the method comprising:
running water through a pipe around which is wrapped a helix plow wave structure;
exciting the helix with a radiofrequency generator; and electromagnetically heating the water to a temperature of at least 35° C.
